(19) United States
(12) Patent Application Publication
(10) Pub. No.: US 2003/0191223 A1
(43) Pub. Date: Oct. 9, 2003

(54) Laser-inscribable coating based on a polymer powder

(75) Inventors: Paul-Ludwig Waterkamp, Recklinghausen (DE); Heinz Scholten, Haltern am See (DE); Wolfgang Christoph, Marl (DE); Thomas Schiffer, Haltern (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/407,167

(22) Filed: Apr. 7, 2003

(30) Foreign Application Priority Data
Apr. 5, 2002 (DE) 102 17 023.1

(51) Int. Cl. C08K 3/18

(52) U.S. Cl. 524/431; 524/435

(57) ABSTRACT

A thermoplastic polymer powder composition which contains a thermoplastic polymer and a laser light-active compound is used for coating of metallic substrates. The resulting coating can be subsequently inscribed using laser light, even after further coating with a finish layer.

### BACKGROUND OF THE INVENTION

1. Field of the Invention

The present invention relates to a polymer powder which contains a laser light-active compound and which is used for the coating of a metallic substrate.

2. Discussion of the Background

High-polymer materials which can be inscribed by means of laser light were described as long ago as 1989 in DE 39 17 294. These are molding compositions, semi-finished products and finished parts, i.e. plastic parts, which are firstly manufactured by injection molding and are subsequently irradiated with a laser and thereby selectively and irreversibly discolored at the irradiated points. The injection moldings can thus be inscribed subsequently and durably.

A successful application example is the inscription of the keys for computer keyboards. Polybutylene terephthalate (PBT) has proven particularly suitable for this purpose, but other polymers, such as PE, PP, PS, nylon-66, nylon-6 and nylon-12, are also suitable for the production of corresponding laser-inscribable injection moldings.

Suitable laser light-active compounds are compounds which have no or only a weak inherent color in the visible region of light and give rise to a mark of high color contrast in the visible spectral region on exposure to laser light whose wavelength is outside the visible region. The lasers used are preferably Nd:YAG lasers having a wavelength of 1064 nm or excimer lasers having wavelengths of 308 nm and 351 nm.

Particularly suitable for this purpose are molybdenum(VI) oxide (MoO₃) and copper hydroxide phosphate (libethenite) Cu₃(PO₄)₂*Cu(OH)₂, abbreviated to CHP below, which can be prepared as described in EP 0 143 933 B1. Further, DE 199 05 358 describes alkali-metal copper diphosphates as laser light-active substances.

From 0.02 to 4.5% by weight of laser-active material are typically employed in the molding compositions. In accordance with DE 39 17 294, from 0.2 to 2.0% by weight of titanium dioxide are additionally added as further additive for improving the contrast. It is furthermore possible to add pigments which absorb in the visible region of light in order to give the component a corresponding inherent color.

Laser-inscribable coating of metal surfaces is complex. For the surface-coatings area, EP 0 665 118 describes laser-inscribable coatings in which basic copper phosphate is used as laser light-active compound. The coating here consists of a 2-component polyurethane coating (hydroxyl-containing acrylate resin plus polyisocyanate resin). After reaction of the two components and curing of the resin in a heating oven, the coating can be inscribed with laser light as described above. Here too, pigments which absorb in the visible region of the spectrum can be added to the coating in order to give the coating a certain inherent color.

However, it is usual in industry for further clear coats to be applied on top of the laser light-inscribable coat in finishes of this type. This multilayer finish is complex to produce. It allows sharp and readily legible inscriptions, but subsequent inscription by a laser after application of the clear coat is only possible to a very restricted extent.

In U.S. Pat. No. 6,238,847, laser-inscribable pastes are applied to a metal surface, which can consist of metal, plastic or glass. These pastes are partially exposed, and unexposed material is subsequently washed off. Clear coats can subsequently be applied as protective layer.

EP 1 110 660 describes laser-inscribable coatings based on diverse noble-metal salts, in particular silver, gold and platinum salts. These coatings are subsequently baked in an oven at temperatures above 500° C. The latter process additionally has the disadvantage of a very high baking temperature.

It is known from industry that metal parts can be coated very simply and effectively with plastic powders. Suitable processes for this purpose are, in particular, fluidized-bed sintering, the minicoat process, electrostatic coating and hot spraying. The processes are now widespread, in particular, in the wire goods industry.

In fluidized-bed sintering, a hot metal part is dipped into a bath containing fluidized plastic powder. The plastic powder melts on the metal surface, adheres thereto and flows to form a uniform film coating.

In the minicoat process, hot, usually small metal parts fall through the plastic powder and bind powder as long as heat is available for melting. The initially rough coating is subsequently melted using a suitable heat source to give a homogeneous film coating.

In electrostatic coating, the plastic powder initially adheres electrostatically to the metal surface. The coated metal part is subsequently heated in an oven to a temperature above the melting point of the plastic, during which the coating flows to give a uniform film coating.

In a variant, namely hot spraying, the powder is sprayed directly onto a hot metal surface, where it melts and flows homogeneously.

In principle, all of the above processes are suitable for the coating of metal parts with a plastic coating. Depending on the size and shape of the components, one or other of these processes offers processing advantages in each case.

### SUMMARY OF THE INVENTION

It is an object of the present invention to develop a polymer powder with which metal parts can be coated simply and quickly, the resulting coating being laser-inscribable.

It is another object of the present invention to provide a coating of a polymer powder which can be inscribed by laser light after being covered with a finish layer.

It is yet another object of the present invention to provide a process for laser inscription after the coating of the polymer powder has been treated with a finish, without thereby restricting the other properties of the plastic coating, for example corrosion protection. Subsequent laser inscription is only possible to a very limited extent in the known processes, in particular in the case of multilayer finishes.

This and other objects have been achieved by the present invention the first embodiment which includes a thermoplastic polymer powder composition, comprising:

a thermoplastic polymer; and

a laser light-sensitive compound.

In another embodiment, the present invention includes a process for the coating of a metallic substrate, comprising:

contacting said metallic substrate with a thermoplastic polymer powder composition which comprises a thermoplastic polymer and a laser light-sensitive compound.

### DETAILED DESCRIPTION OF THE INVENTION

The inventors of the present invention have found that polymer powders comprising copper hydroxide phosphates, alkaline copper phosphates, molybdenum trioxide and/or titanium dioxide are highly suitable for laser-inscribable plastic coatings. Polymers which can be used are all pulverulent plastics with which coating by one of the above-mentioned coating methods, such as fluidized-bed sintering, the minicoat process, electrostatic coating and hot spraying, is possible.

Any thermoplastic polymer can be used as a polymer powder. In practice, thermoplastic coatings of polyethylene, PVC, polyester and polyamide have proven particularly successful. Amorphous epoxide-based thermoplastic polymers have recently also become available. For technically demanding coatings, polyamides are particularly suitable, especially those comprising nylon-11 and/or nylon-12. They exhibit an advantageous processing window, in particular in the case of fluidized-bed sintering, and offer plastic coatings having excellent mechanical and chemical properties, such as, for example, low water absorption, high resistance to salt water and cleaning materials, high elasticity, high abrasion resistance and good scratch resistance.

The polymer powder required for the process according to the present invention can be obtained by production processes, such as, for example, grinding with subsequent sieving and/or plastification. Very particularly suitable powders for the plastic coatings according to the present invention are those which comprise a polyamide precipitation powder as described in DE 29 06 647, because a polyamide powder prepared by this process has particularly round grains with good fluidization properties.

The powders according to the present invention have a mean particle size d₅₀ of between 10 and 150 μm, with the particle size upper limit through protective sieving generally being between 250 and 400 μm and the particle size lower limit being from 1 to 5 μm. The mean particle size includes all values and subvalues therebetween, especially including 20, 30, 40, 50, 60, 70, 80, 90, 100, 110, 120, 130 and 140 μm. The particle size upper limit includes all values and subvalues therebetween, especially including 260, 270, 280, 290, 300, 310, 320, 330, 340, 350, 360, 370, 380 and 390 μm. The particle size lower limit includes all values and subvalues therebetween, especially including 2, 3 and 4 μm. The optimum particle distribution depends on the coating method selected in each case. Electrostatic powders generally have a lower mean particle size than, for example, fluidized-bed sintering powders.

The laser light-active compounds can, in accordance with the present invention, be introduced into the polymer powder in various ways:

1. The laser light-active compounds can be compounded into the respective plastic granules with the aid of an extruder. The granules are subsequently ground, sieved and/or classified.

2. In the precipitation process as described in DE 29 06 647 B1, the laser light-active components are added during the precipitation or are adsorbed as a solution onto the precipitated powder while the latter is still moist.

3. The laser light-active compounds can be mixed into the respective powder in the form of a dry blend.

The laser light-active compounds are generally employed in proportions of from 0.01 to 15% by weight, preferably from 0.1 to 10% by weight. The amount of the laser light-active compounds includes all values and subvalues therebetween, especially including 0.05, 0.1, 0.5, 1, 2, 3, 4, 5, 6, 7, 8, 9, 10, 11, 12, 13 and 14% by weight.

Non-limiting examples of laser light-active compounds which may be mentioned are the following: copper hydroxide phosphates, which can be prepared, for example, in accordance with EP 0 143 933; alkali-metal copper diphosphates, such as lithium copper diphosphate, sodium copper diphosphate and potassium copper diphosphate, which are readily formed through reaction of tetra(alkali metal) diphosphate and Cu(II) salts as described in Gmelin's Handbook of Inorganic Chemistry. Due to the low inherent color, the potassium salt is particularly preferred. Phosphate salts are commercially available, for example as Budit 322 from Chemische Fabrik Budenheim. Preferred metal oxides are, in particular, molybdenum(VI) oxide and titanium(IV) oxide. In the case of titanium dioxide, the following can be used: 1) white pigments, such as, for example, Kronos 2310 or Huntsman Tioxide RTC 30, and 2) nanoscale grades, which are available, for example, from Degussa.

The powder according to the present invention is suitable for simple and effective coating of diverse metal components. Preferred metals are, in particular, iron, steel, aluminium and/or copper, as well as alloys thereof. In addition to the above-mentioned properties of the plastic coating, which are known to be good, the ability of the coating to be laser-inscribed additionally offers the user a simple way of inscribing finished components durably and permanently. This allows important manufacturer's information, such as, for example, component and batch identification numbers, manufacturer's name, production date, test and control numbers, etc., to be applied easily and quickly to the components. Such information was hitherto frequently stamped on metal sheets and attached to the component in a complex manner using rivets. The powder according to the invention also allows precise and complete inscription on small and/or angled components, as well as curved surfaces (wires, pipes) to which an identification plate can only be attached with difficulty.

In contrast to the coatings claimed in EP 0 665 118, the polymer powder according to the present invention forms a thermoplastic coating in which binder is unnecessary. Thus, in a preferred embodiment, the coating of the present invention contains no binder.

Having generally described this invention, a further understanding can be obtained by reference to certain specific examples which are provided herein for purposes of illustration only, and are not intended to be limiting unless otherwise specified.

### EXAMPLES

The contrast is determined using a DataColor SF 600 calorimeter. The standard color values Y for the laser-irradiated and unexposed surface are measured and used to calculate the contrast ratio:

$$CR = \frac{Y unexposed}{Y laser \text{-} exposed} * 100$$

### Example 1 (Comparative Example)

A steel plate (100*60*2 mm) was pretreated by degreasing, blasting and deburring. It was subsequently heated in an oven at 420° C. for 10 minutes and then coated for 3 seconds by fluidized-bed sintering with a natural-colored nylon-12 precipitation powder as described in DE 29 06 647 B 1 having a mean particle diameter of 90 μm. After immersion, the coating was uniformly melted in air for 30 seconds, and the plate was subsequently quenched in a water bath (20° C.). The layer thickness of the polyamide coating was 280 μm.

The coated plate was exposed using a Nd:YAG laser (1064 nm) with a power consumption of 18.5 A and a pulse frequency of 2500 Hz at a speed of 180 mm/sec.

Discoloration of the polymer layer did not occur, but the irradiated area detached from the substrate, with the coating forming a blister at this point. A contrast value C could not be determined.

### Example 2

Analogously to Example 1, a steel plate was coated by fluidized-bed sintering with a nylon-12 precipitation powder as described in DE 29 06 647 B1 having a mean particle diameter of 90 μm which comprised 1 part of Budit 322 mixed in the form of a dry blend. Pretreatment, heating, coating, printing and exposure were carried out as in Example 1. The layer thickness of the polymer layer was 270 μm.

The irradiated area exhibited a dark, slightly roughened surface with C=79.2. The irradiated area did not detach from the substrate and exhibited no corrosion after water storage (5 days, 20° C.).

### Example 3

The coating from Example 2 was repeated using a nylon-12 precipitation powder having a mean particle diameter of 90 μm to which 6 parts of titanium dioxide (Kronos, RTC 30) had been incorporated in the precipitation reactor as described in DE 29 06 647 B1. The layer thickness was 270 μm.

The irradiated area exhibited a pale-grey, slightly roughened surface with C=125.7. The irradiated area did not detach from the substrate and exhibited no corrosion after water storage (5 days, 20° C.).

### Example 4

The coating from Example 3 was repeated, with the nylon-12 powder additionally comprising 1 part of Budit 322 mixed in the form of a dry blend. The irradiated area exhibited a dark-grey, slightly roughened surface with C=128.3.

The irradiated area did not detach from the substrate and exhibited no corrosion after water storage (5 days, 20° C.).

German patent application 10217023.1 filed Apr. 5, 2002, is incorporated herein by reference. Numerous modifications and variations on the present invention are possible in light of the above teachings. It is therefore to be understood that within the scope of the appended claims, the invention may be practiced otherwise than as specifically described herein.

1. A thermoplastic polymer powder composition, comprising:
a thermoplastic polymer; and
a laser light-sensitive compound.

2. The thermoplastic polymer powder composition according to claim 1, wherein said laser light-sensitive compound is selected from the group consisting of an alkali-metal copper diphosphate, molybdenum(VI) oxide, titanium dioxide and a mixture thereof.

3. The thermoplastic polymer powder composition according to claim 1, comprising 0.01%-15% of said laser light-sensitive compound.

4. The thermoplastic polymer powder composition according to claim 1, wherein said thermoplastic polymer is selected from the group consisting of a polyethylene, a polyvinylchloride, a polyester, and a polyamide.

5. The thermoplastic polymer powder composition according to claim 1, comprising nylon-11, nylon-12 and a mixture thereof.

6. The thermoplastic polymer powder composition according to claim 1, having a mean particle size d₅₀ of between 10 and 150 μm.

7. The thermoplastic polymer powder composition according to claim 1, having a particle size of not larger than 400 μm.

8. The thermoplastic polymer powder composition according to claim 1, having a particle size of not smaller than 1 μm.

9. A process for the coating of a metallic substrate, comprising:
contacting said metallic substrate with a thermoplastic polymer powder composition which comprises a thermoplastic polymer and a laser light-sensitive compound.

10. The process according to claim 9, further comprising:
compounding said laser light-sensitive compound into thermoplastic polymer granules using an extruder.

11. The process according to claim 9, further comprising:
adding said laser light-sensitive compound during a polymer powder precipitation process to said thermoplastic polymer.

12. The process according to claim 9, further comprising:
mixing said laser light-sensitive compound into said thermoplastic polymer by dry-blending.

13. The process according to claim 9, wherein said laser light-sensitive compound is selected from the group consisting of a basic copper phosphate, molybdenum(VI) oxide, titanium dioxide and a mixture thereof.

14. The process according to claim 9, wherein said thermoplastic polymer powder composition comprises 0.01%-15% of said laser light-sensitive compound.

15. The process according to claim 9, wherein said thermoplastic polymer is selected from the group consisting of a polyethylene, a polyvinylchloride, a polyester, and a polyamide.

16. The process according to claim 9, wherein said thermoplastic polymer powder composition comprises nylon-11, nylon-12 and a mixture thereof.

17. The process according to claim 9, wherein said thermoplastic polymer powder composition has a mean particle size d₅₀ of between 10 and 150 μm.

18. The process according to claim 9, wherein said thermoplastic polymer powder composition has a particle size of not larger than 400 μm.

19. The process according to claim 9, wherein said thermoplastic polymer powder composition has a particle size of not smaller than 1 μm.

20. A metallic substrate coated according to the process of claim 9.
